(19) United States
(12) Patent Application Publication
(10) Pub. No.: US 2021/0404222 A1
(43) Pub. Date: Dec. 30, 2021

(54) STAND LOCK KIT AND METHOD FOR USING THE SAME

(71) Applicant: SINOX CO., LTD, New Taipei City (TW)

(72) Inventor: Jia-Qi WU, New Taipei City (TW)

(73) Assignee: SINOX CO., LTD, New Taipei City (TW)

(21) Appl. No.: 17/356,099

(22) Filed: Jun. 23, 2021

(30) Foreign Application Priority Data
Jun. 24, 2020 (TW) 109121600

(51) Int. Cl. E05B 73/00

(52) U.S. Cl. CPC E05B 73/0082; E05B 73/0005

(57) ABSTRACT

A stand lock kit and a method for using the same are provided. The stand lock kit of the present invention includes a stand lock and a casing. The stand lock includes a body, a first support arm, and a second support arm. The first and the second support arms are disposed in the body, wherein at least one of them is capable of moving with respect to the body to secure the display of the electronic device between them and to make the relative position of the body fixed. The casing has a casing connecting unit. One end of the casing connecting unit connects to the casing, while a free end of the same is capable of inserting into the first lock hole of the body and being restricted from leaving the first lock hole by the stand lock core. The expansion electronic device is accommodated in the casing.

### BACKGROUND

### Field of the Invention

The present invention generally relates to a stand lock kit and a method using the same. More particularly, the present invention relates to a stand lock kit for use with an expansion electronic device and an electronic device having a display, and a method using the stand lock kit.

### Related Art

In order to prevent thieves from stealing laptops, laptop locks can be connected to the lock hole of laptops by a latch unit, wherein a locking operation enables the latch unit to be secured in the lock hole when the latch unit is connected to the lock hole. An arrangement of the lock hole and a lock connected thereto usually does not interfere with a user's operation and the lock hole is located at the side of a laptop. For example, a lock can be close to the lock hole of the laptop located at the back side to allow a latch unit thereof to enter the lock hole without interfering with the operation of the lock or the laptop. However, since laptops are getting thinner, the thickness on the side is therefore reduced, and the size of the lock may affect the alignment between the latch unit and the lock hole. Consequently, the lock and the laptop may not both rest on a supporting surface after the latch unit of the lock is inserted into the lock hole, wherein the back side of the laptop may be raised due to the lock, which may therefore affect the user's operation and the lock's efficacy. Therefore, stand locks are used to lock laptops.

On the other hand, users can further connect laptops with expansion electronic devices such as docking stations to increase the expandability of laptops or to make the wiring more convenient. However, due to their relatively high unit prices and the ease of turning them into cash, these products are more likely to be stolen. Therefore, anti-theft solutions are necessary.

### SUMMARY OF THE INVENTION

The stand lock kit of the present invention is for use with an expansion electronic device and an electronic device having a display. The stand lock kit includes a stand lock and a casing. The stand lock includes a body, a first support arm, and a second support arm. The body includes at least a first lock hole, at least a stand lock core, and a first end portion and a second end portion disposed in the opposite ends of the body. The first support arm is disposed in the body. The second support arm is disposed in the body, wherein at least one of the first support arm and the second support arm is capable of moving with respect to the body to secure the display of the electronic device between the first support arm and the second support arm and to make the relative position of the body with respect to the electronic device fixed. The casing has a casing connecting unit. One end of the casing connecting unit connects to the casing. A free end of the casing connecting unit is capable of inserting into the first lock hole and being restricted from leaving the first lock hole by the stand lock core. The expansion electronic device is accommodated in the casing.

In one embodiment, the stand lock core is capable of restricting the movement of at least one of the first support arm and the second support arm to make the relative position of the body with respect to the electronic device fixed.

In one embodiment, the expansion electronic device is a docking station.

In one embodiment, the body further includes a second lock hole.

In one embodiment, a lock set can be locked in the second lock hole.

The method for using the stand lock kit includes: (A1000) securing the display of the electronic device between the first support arm and the second support arm; (A2000) inserting the free end into the first lock hole; (A3000) locking the stand lock core to restrict the free end from leaving the first lock hole and to restrict the movement of at least one of the first support arm and the second support arm to make the relative position of the body with respect to the electronic device fixed.

In one embodiment, the method for using the stand lock kit further includes: (A4100) using a first cable to connect the casing connecting unit to an object.

In one embodiment, the method for using the stand lock kit further includes: (A4200) locking a lock set in the second lock hole, wherein the lock set is connected to a lock set connecting unit.

In one embodiment, the method for using the stand lock kit further includes: (A4300) fixing the body on an object.

The method for using the stand lock kit includes: (B1000) securing the display of the electronic device between the first support arm and the second support arm; (B2000) connecting one end of the first cable to an object and inserting the other end into the first lock hole; and (B3000) locking the stand lock core to restrict the end of the first cable from leaving the first lock hole and to restrict the movement of at least one of the first support arm and the second support arm to make the relative position of the body with respect to the electronic device fixed.

The method for using the stand lock kit includes: (C1000) securing the display of the electronic device between the first support arm and the second support arm; (C2000) locking a lock set in the second lock hole, wherein the lock set is connected to a lock set connecting unit; and (C3000) locking the stand lock core to restrict the end of the first cable from leaving the first lock hole and to restrict the movement of at least one of the first support arm and the second support arm to make the relative position of the body with respect to the electronic device fixed.

The method for using the stand lock kit includes: (D1000) providing a lock set, wherein the lock set is connected to a lock set connecting unit; (D2000) passing the end of the lock set connecting unit other than the end connected to the lock set through the casing and fixing it on an object; and (D3000) locking the lock set in a third lock hole of the electronic device.

### BRIEF DESCRIPTION OF THE DRAWINGS

FIGS. 1A and 1B are schematic diagrams of an embodiment of a stand lock kit of the present invention.

FIGS. 2A to 5B are schematic diagrams showing how to lock an electronic device having a display with the stand lock kit of the present invention.

FIG. 6 is a schematic flowchart of an embodiment of a method for using the stand lock kit of the present invention.

FIG. 7A is a schematic flowchart of different embodiment of a method for using the stand lock kit of the present invention.

FIG. 7B is a schematic diagram of an embodiment showing how to lock an expansion electronic device and an electronic device having a display on an object with the stand lock kit of the present invention.

FIG. 8A is a schematic flowchart of a different embodiment of a method for using the stand lock kit of the present invention.

FIG. 8B is a schematic diagram of a different embodiment showing how to locking an expansion electronic device and an electronic device having a display on an object with the stand lock kit of the present invention.

FIG. 9A is a schematic flowchart of a different embodiment of a method for using the stand lock kit of the present invention.

FIG. 9B is a schematic diagram of a different embodiment showing how to lock an expansion electronic device and an electronic device having a display on an object with the stand lock kit of the present invention.

FIG. 10A is a schematic flowchart of a different embodiment of a method for using the stand lock kit of the present invention.

FIG. 10B is a schematic diagram of an embodiment showing how to lock an electronic device having a display on an object with the stand lock kit of the present invention.

FIG. 11A is a schematic flowchart of a different embodiment of a method for using the stand lock kit of the present invention.

FIG. 11B is a schematic diagram of a different embodiment showing how to lock an electronic device having a display on an object with the stand lock kit of the present invention.

FIG. 12A is a schematic flowchart of a different embodiment of a method for using the stand lock kit of the present invention.

FIG. 12B is a schematic diagram of a different embodiment showing how to lock an electronic device having a display on an object with the stand lock kit of the present invention.

### DETAILED DESCRIPTION

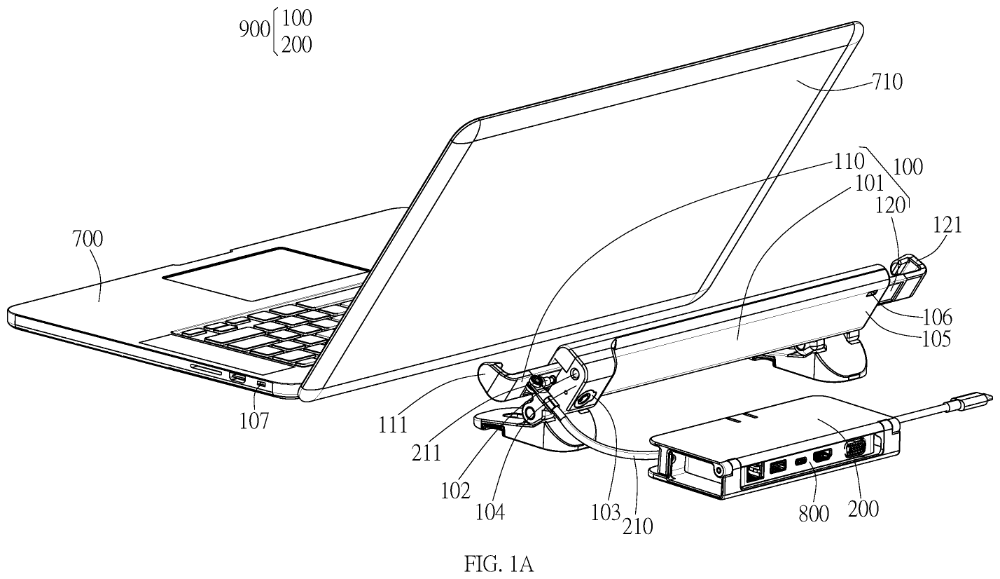

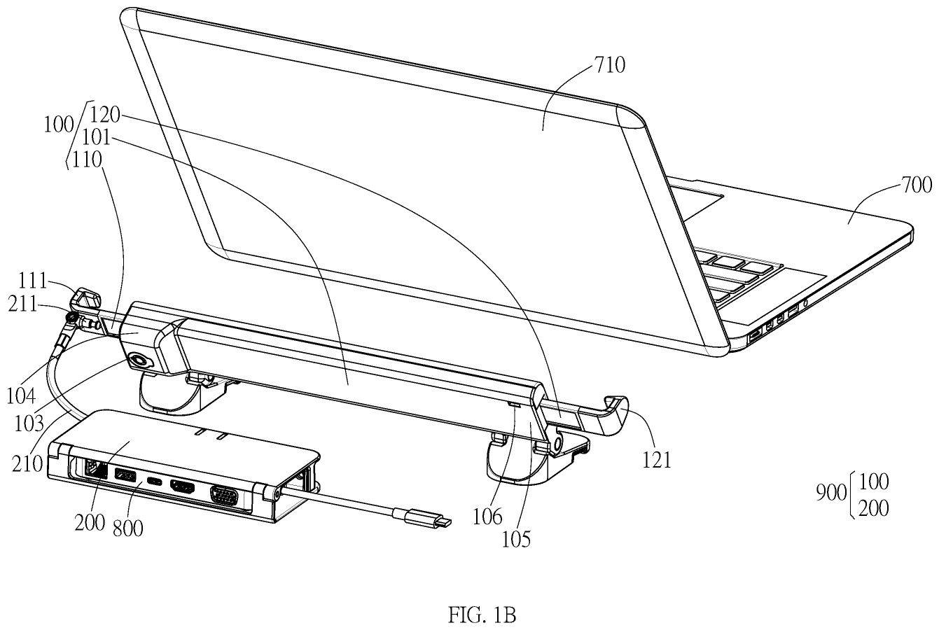

As shown in the embodiments in FIGS. 1A and 1B, the stand lock kit 900 of the present invention is preferably for use with an expansion electronic device 800 and an electronic device 700 having a display. The electronic device 700 could be laptops, tablets, etc. The expansion electronic device 800, preferably a docking station, has a plurality of ports to connect to electronic devices having displays, power supplies, displays, interface operating devices (e.g. keyboards, mice), data accessing devices (e.g. memory card readers, disc players), data storage devices (e.g. hard drives, memory cards, flash disks), etc.

As shown in the embodiments in FIGS. 1A and 1B, the stand lock 900 kit includes a stand lock 100 and a casing 200. The stand lock 100 includes a body 101, a first support arm 110, and a second support arm 120. The body 101 includes a first lock hole 102, a stand lock core 103, and a first end portion 104 and a second end portion 105 disposed on the opposite ends of the body 101. In the embodiments, the stand lock core 103 is a key lock core, wherein users can lock and unlock it with keys. In different embodiments, however, the stand lock core 103 can be a different lock core such as a combination lock core. On the other hand, numbers and locations of lock holes and lock cores can be modified in accordance with the requirement of manufacturing, design, and use. For example, TSA lock holes and lock cores can be added for the customs or the security personnel to unlock.

As shown in the embodiments in FIGS. 1A and 1B, the first support arm 110 is disposed in the body 101. The second support arm 120 is disposed in the body 101. Specifically, a portion of the first support arm 110 extends out of the body 101 from the first end portion 104, wherein a first limiting unit 111 is disposed at an end portion of the first support arm 110 extending out of the body 101. A portion of the second support arm 120 extends out of the body 101 from the second end portion 105, wherein a second limiting unit 121 is disposed at an end portion of the second support arm 120 extending out of the body 101. At least one of the first support arm 110 and the second support arm 120 is capable of moving with respect to the body 101 to secure the display 710 of the electronic device 700 between the first support arm 110 and the second support arm 120, specifically between the first limiting unit 111 and the second limiting unit 121, and to make the relative position of the body 101 with respect to the electronic device 700 fixed.

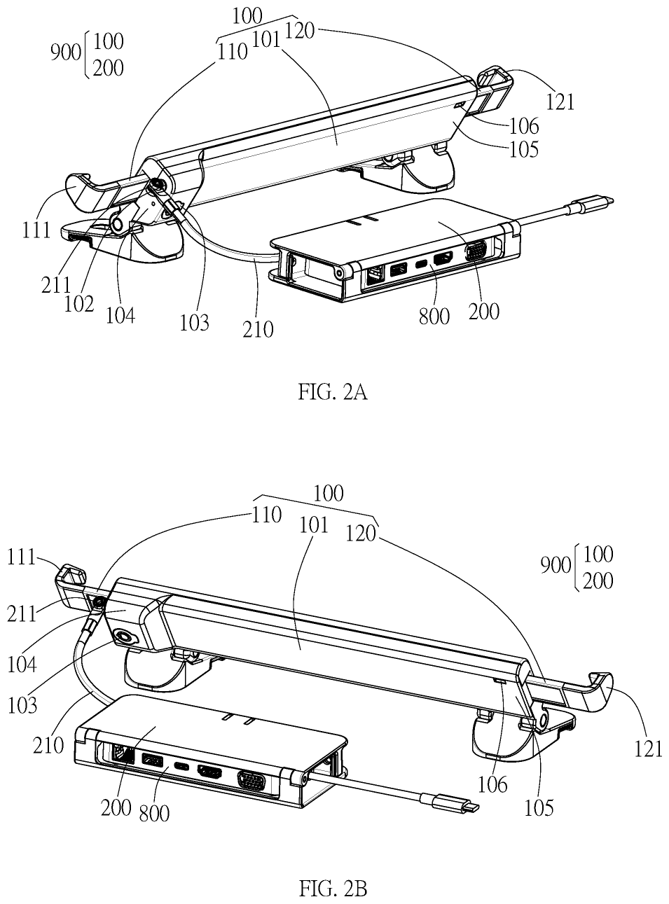

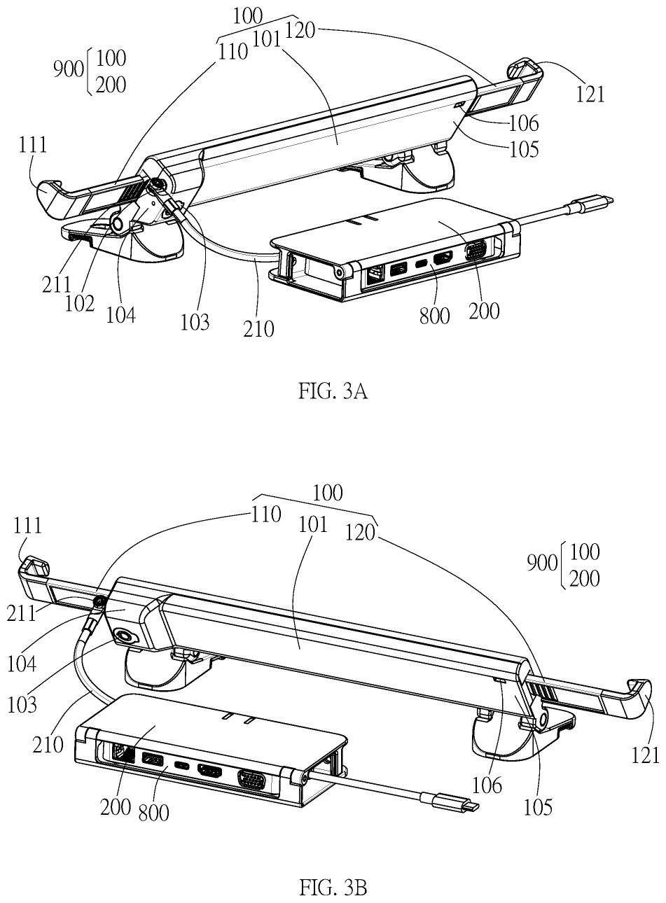

More particularly, as shown in the embodiments in FIGS. 2A and 2B, the first support arm 110 and the second support arm 120 are accommodated in the body 101 to a great extent before the electronic device is fixed on the body 101. Afterward, as shown in the embodiments in FIGS. 3A and 3B, under the circumstance where the stand lock core 103 is unlocked, a user can pull out the first support arm 110 and the second support arm 120 with respect to the body 101 to increase the distance between the first support arm 110 and the second support arm 120. In this embodiment, the first support arm 110 and the second support arm 120 are pulled out by the same distance with respect to the body 101. In different embodiments, however, the first support arm 110 and the second support arm 120 can be pulled out by different distances with respect to the body 101, or only one of them is pulled out, to make the distance between the first support arm 110 and the second support arm 120, specifically between the first limiting unit 111 and the second limiting unit 121, large enough for putting the display in. On the other hand, the form of the first limiting unit 111 and the second limiting unit 121 can be modified in accordance with the requirement of use. For example, they can be U-shapes having openings facing each other for clamping the display therebetween.

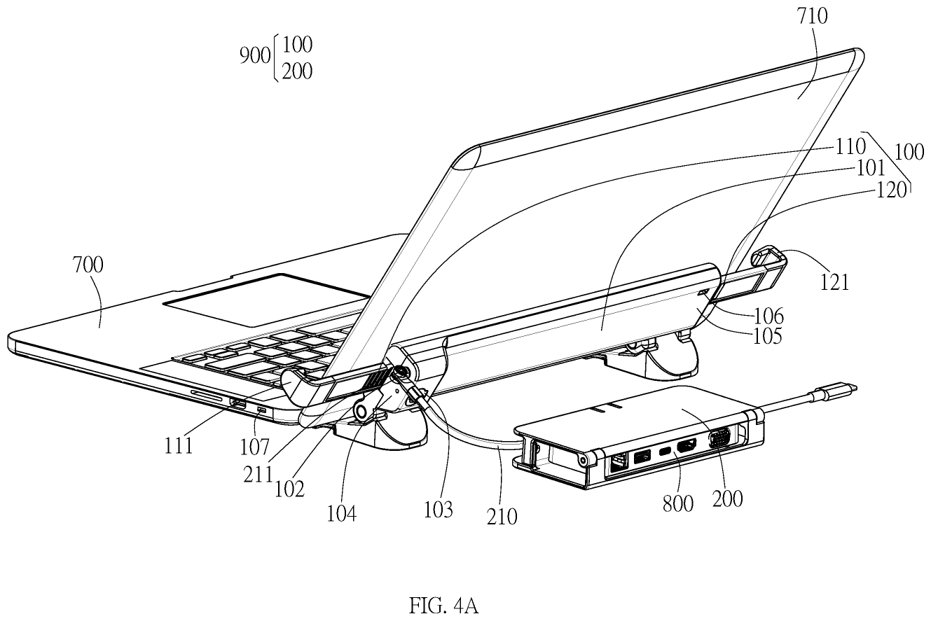

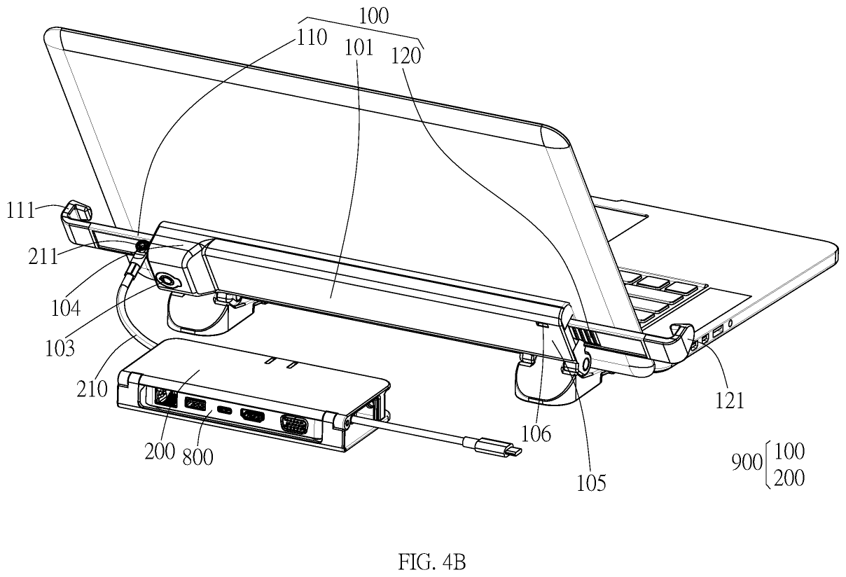

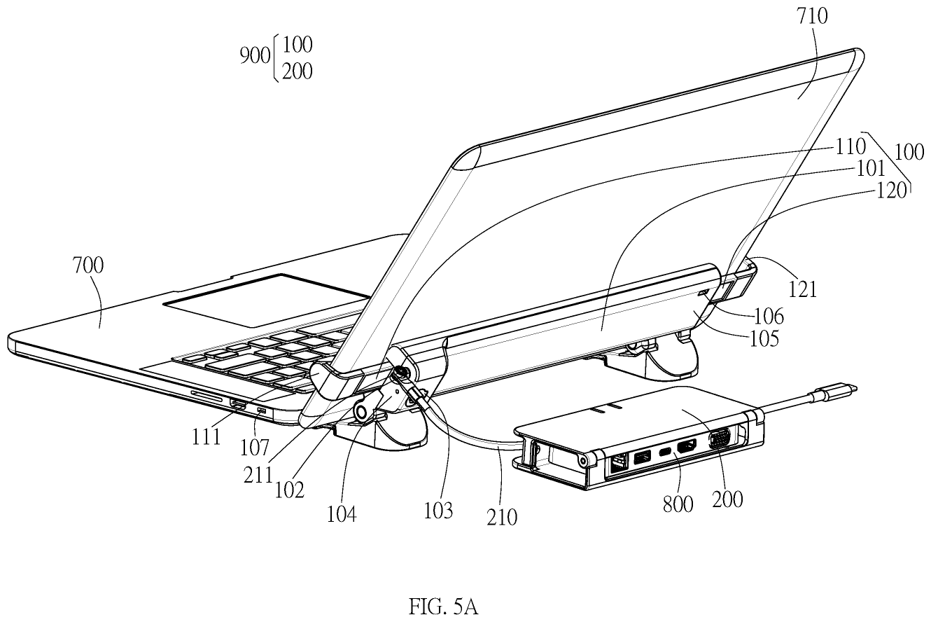

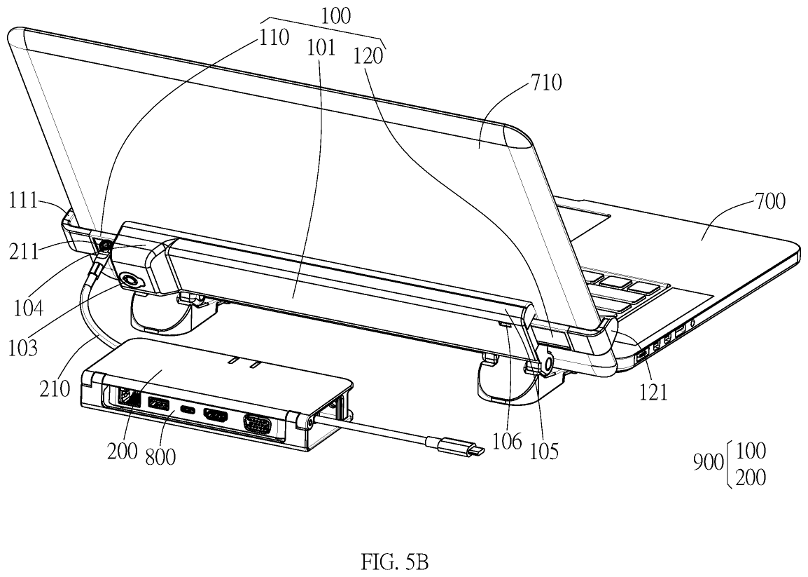

As shown in the embodiments in FIGS. 4A and 4B, the user can put the display 710 of the electronic device 700 between the first limiting unit 111 and the second limiting unit 121. Afterward, as shown in the embodiments in FIGS. 5A and 5B, the user can push the first support arm 110 and the second support arm 120 into the body 101 to decrease the distance between the first support arm 110 and the second support arm 120 and to secure the display 710 of the electronic device 700 between the first support arm 110 and the second support arm 120. Then, the user can lock the stand lock core 103 to restrict the movement of the first support arm 110 and the second support arm 120 with respect to the body 101 and hence to make the relative position of the body 101 with respect to the electronic device 700 fixed, in other words, to lock the electronic device 700 on the stand lock 100.

On the other hand, as shown in the embodiments in FIGS. 1A to 5B, the casing 200 has a casing connecting unit 210. One end of the casing connecting unit 210 connects to the casing 200. A free end 211 of the casing connecting unit 210 is capable of inserting into the first lock hole 102 and being restricted from leaving the first lock hole 102 by the stand lock core 103. The expansion electronic device 800 is accommodated in the casing 200. Accordingly, the casing 200 can be locked on the stand lock 100 and hence the expansion electronic device 800 can be locked on the stand lock 100. The casing connecting unit 210 is preferably a cable, which can be collected into the casing 200 by a device such as a cord winder.

Accordingly, the expansion electronic device 800 and the electronic device 700 having a display can be locked on the stand lock 100. Moreover, one can select a suitable casing 200 to go with the stand lock 100 in accordance with the specifications of the expansion electronic device 800, such as shape and size, making it more economic and convenient to use.

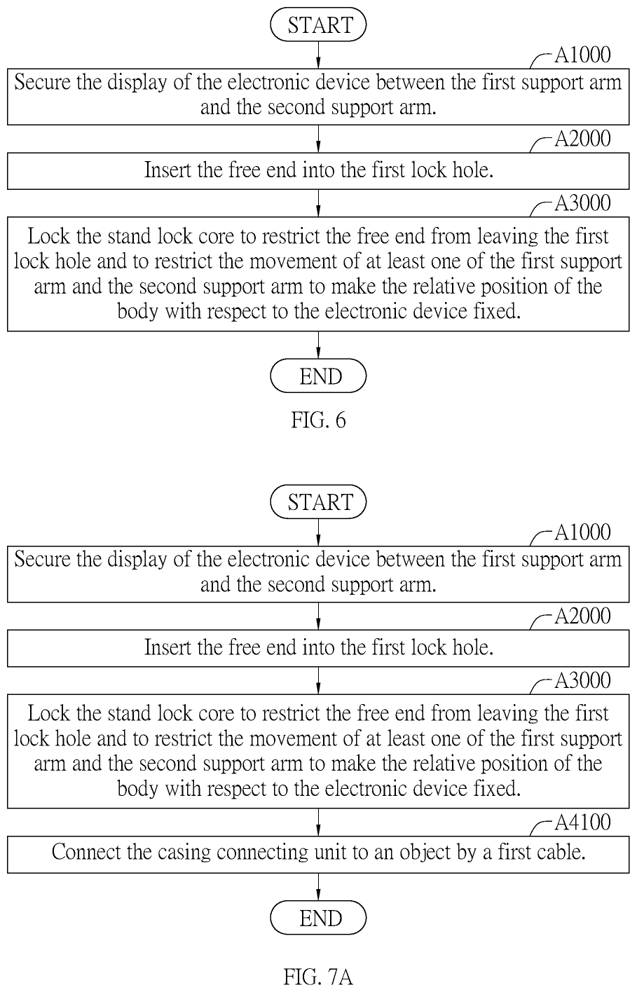

As shown in the flowchart of an embodiment shown in FIG. 6, the method for using the stand lock kit of the present invention includes, for example, the following steps.

Step (A1000): Secure the display of the electronic device between the first support arm and the second support arm. More particularly, as shown in the embodiments in FIGS. 2A to 5B, secure the display 710 of the electronic device 700 between the first limiting unit 111 of the first support arm 110 and the second limiting unit 121 of the second support arm 120.

Step (A2000): Insert the free end into the first lock hole. More particularly, as shown in the embodiments in FIGS. 5A to 5B, Insert the free end 211 into the first lock hole 102.

Step (A3000): Lock the stand lock core to restrict the free end from leaving the first lock hole and to restrict the movement of at least one of the first support arm and the second support arm to make the relative position of the body with respect to the electronic device fixed. More particularly, as shown in the embodiments in FIGS. 5A to 5B, use a key to lock the stand lock core 103 to restrict the free end 211 from leaving the first lock hole 102 and to restrict the movement of at least one of the first support arm 110 and the second support arm 120 to make the relative position of the body 101 with respect to the electronic device 700 fixed.

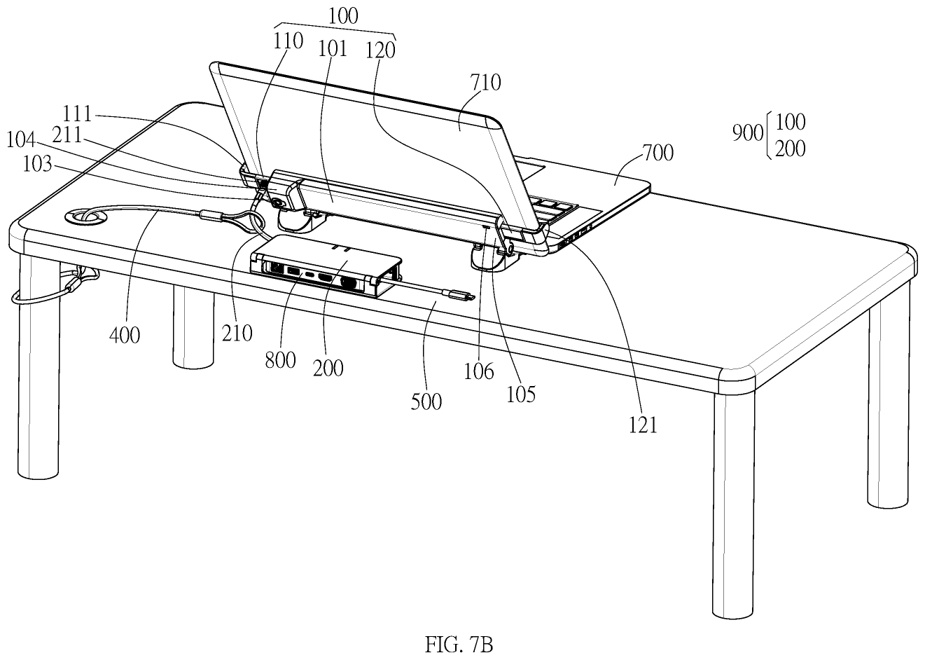

As shown in the flowchart of a different embodiment shown in FIG. 7A, the method for using the stand lock kit of the present invention further includes step (A4100): Connect the casing connecting unit to an object by a first cable. More particularly, as shown in the embodiment in FIG. 7B, the user can wind and fix the first cable 400 on a large object 500 such as a desk or a cabinet and then connect the first cable 400 to the casing connecting unit 210 by means of methods such as socketing. Thus, the expansion electronic device 800 and the electronic device 700 locked on the stand lock kit 900 can further be locked on the object 500.

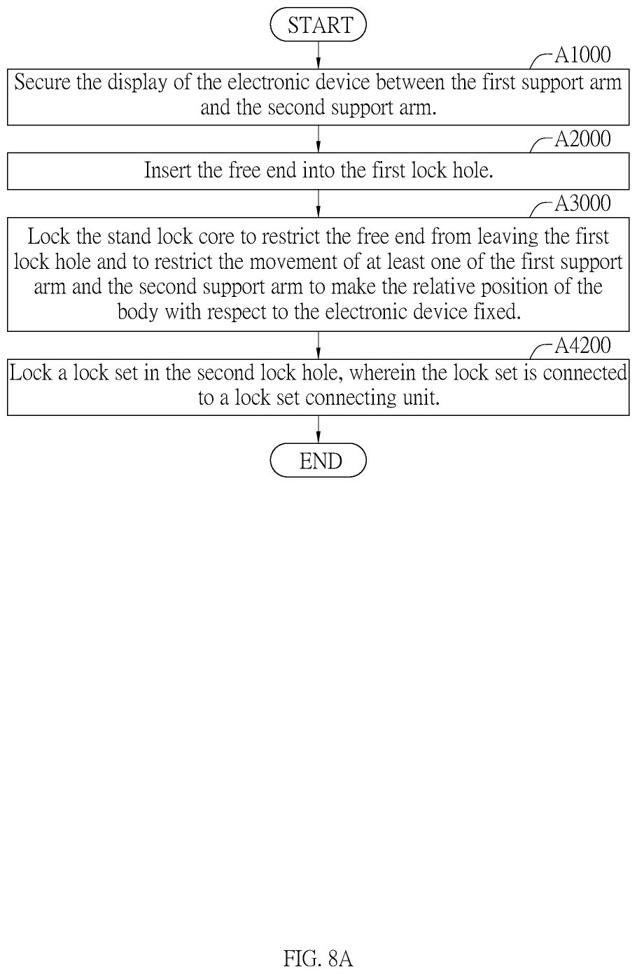

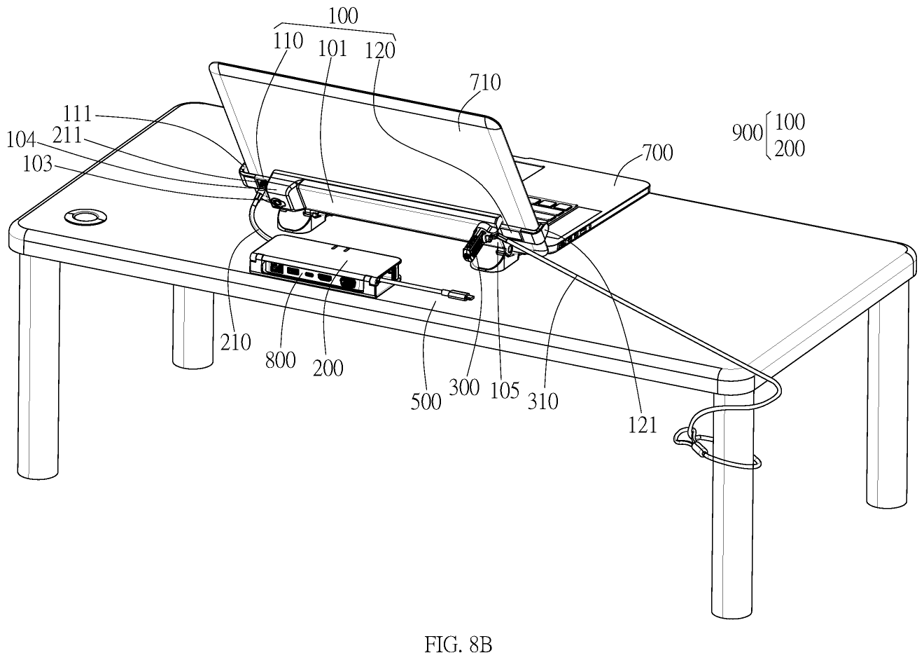

As shown in the flowchart of a different embodiment shown in FIG. 8A, the method for using the stand lock kit of the present invention further includes step (A4200): Lock a lock set in the second lock hole, wherein the lock set is connected to a lock set connecting unit. More particularly, as shown in the embodiment in FIG. 8B, the user can wind and fix the lock set connecting unit 310, which is connected to the lock set 300, on a large object 500 such as a desk or a cabinet and then lock the lock set 300 in the second lock hole 106 (see FIG. 7B). Thus, the expansion electronic device 800 and the electronic device 700 locked on the stand lock kit 900 can further be locked on the object 500.

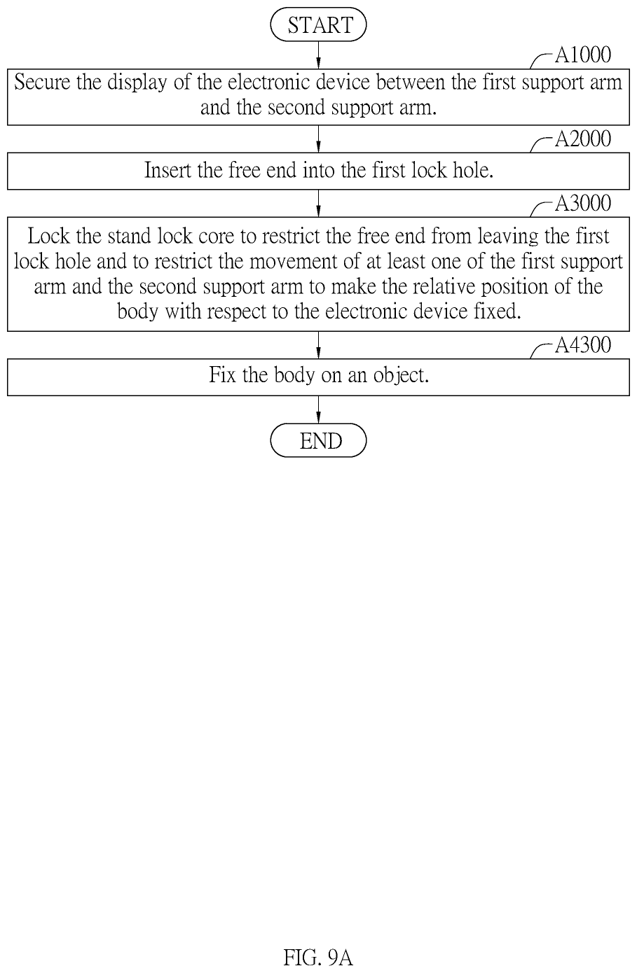

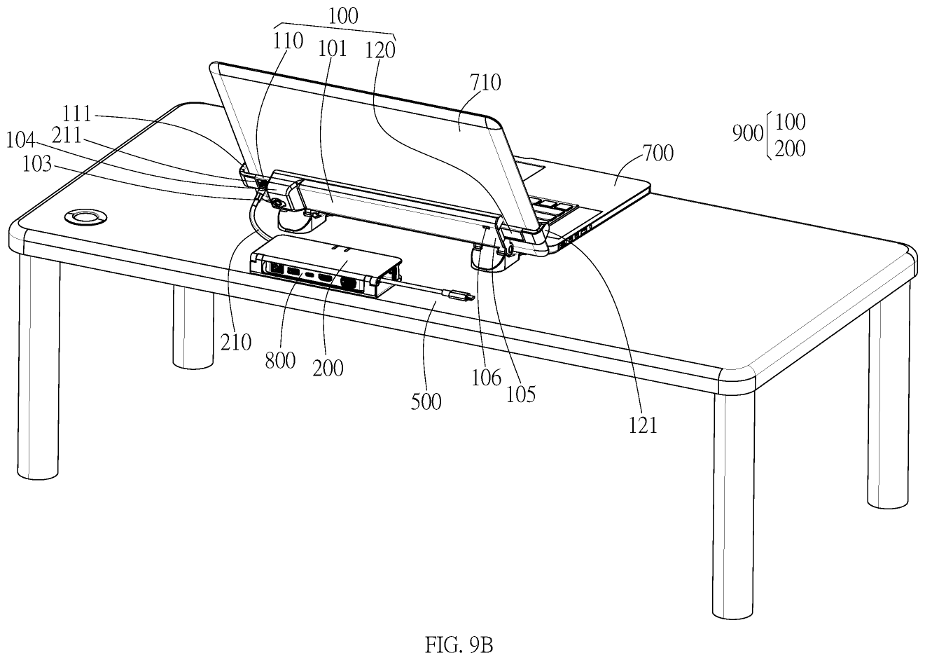

As shown in the flowchart of a different embodiment shown in FIG. 9A, the method for using the stand lock kit of the present invention further includes step (A4300): Fix the body on an object. More particularly, as shown in the embodiment in FIG. 9B, the body 101 can be fixed on a large object 500 such as a desk or a cabinet by means of methods such as screwing or pasting. Thus, the expansion electronic device 800 and the electronic device 700 locked on the stand lock kit 900 can further be locked on the object 500.

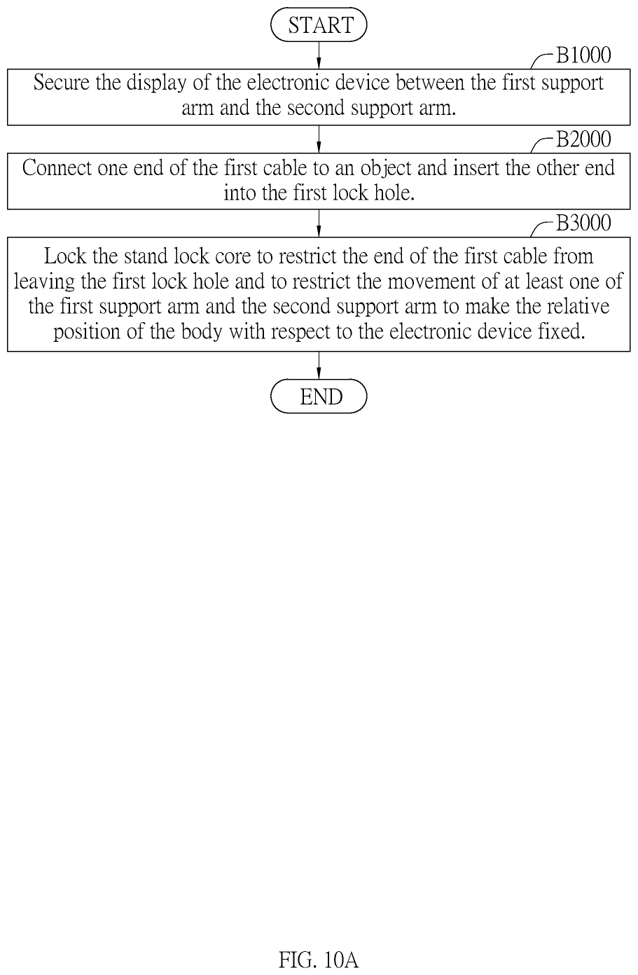

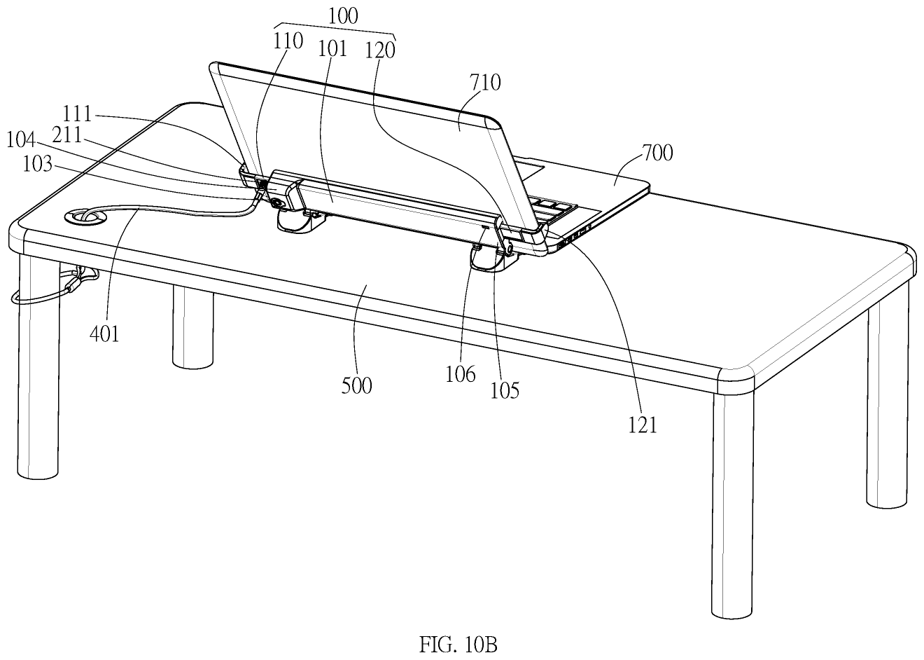

In different embodiments, the stand lock 100 can be used alone. As shown in the flowchart of a different embodiment shown in FIG. 10A, the method for using the stand lock kit of the present invention includes, for example, the following steps. Step (B1000): Secure the display of the electronic device between the first support arm and the second support arm. Step (B2000): Connect one end of the first cable to an object and insert the other end into the first lock hole. Step (B3000): Lock the stand lock core to restrict the end of the first cable from leaving the first lock hole and to restrict the movement of at least one of the first support arm and the second support arm to make the relative position of the body with respect to the electronic device fixed. More particularly, as shown in the embodiment in FIG. 10B, the user can wind and fix the first cable 401 on a large object 500 such as a desk or a cabinet and then inset the other end into the first lock hole 102 (see FIG. 5A) and lock the stand lock core 103. Thus, the electronic device 700 locked on the stand lock kit 900 can further be locked on the object 500.

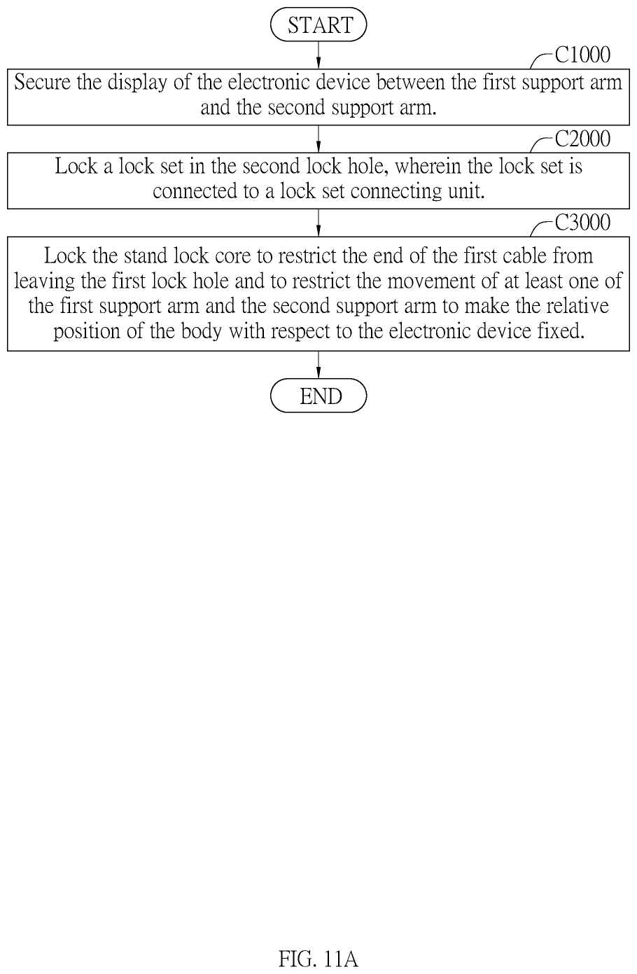

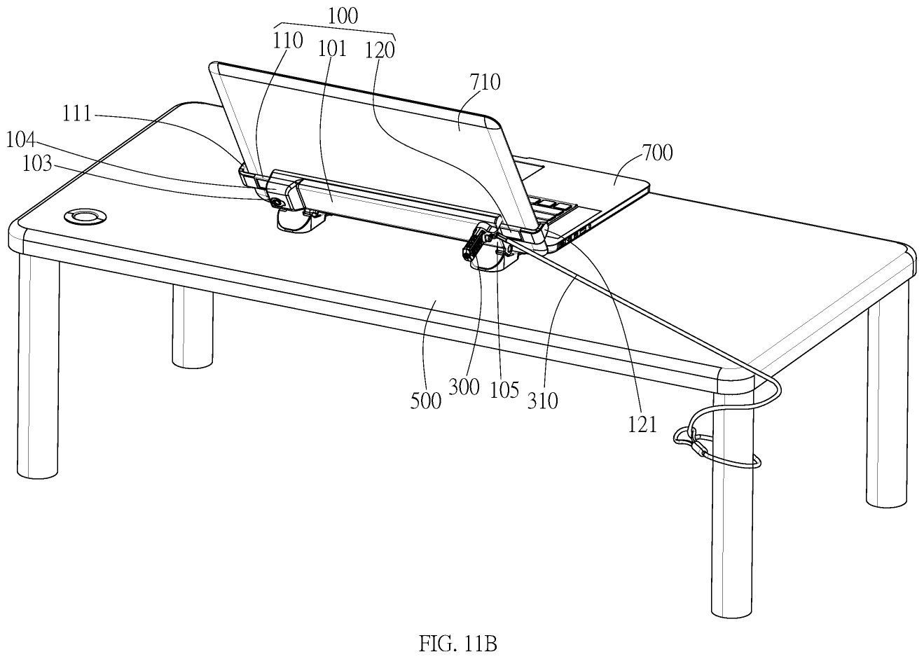

As shown in the flowchart of a different embodiment shown in FIG. 11A, the method for using the stand lock kit of the present invention includes, for example, the following steps. Step (C1000): Secure the display of the electronic device between the first support arm and the second support arm. Step (C2000): Lock a lock set in the second lock hole, wherein the lock set is connected to a lock set connecting unit. Step (C3000): Lock the stand lock core to restrict the end of the first cable from leaving the first lock hole and to restrict the movement of at least one of the first support arm and the second support arm to make the relative position of the body with respect to the electronic device fixed. More particularly, as shown in the embodiment in FIG. 11B, the user can wind and fix the lock set connecting unit 310, which is connected to the lock set 300, on a large object 500 such as a desk or a cabinet and then lock the lock set 300 in the second lock hole 106 (see FIGS. 5A and 5B). Thus, the electronic device 700 locked on the stand lock kit 900 can further be locked on the object 500.

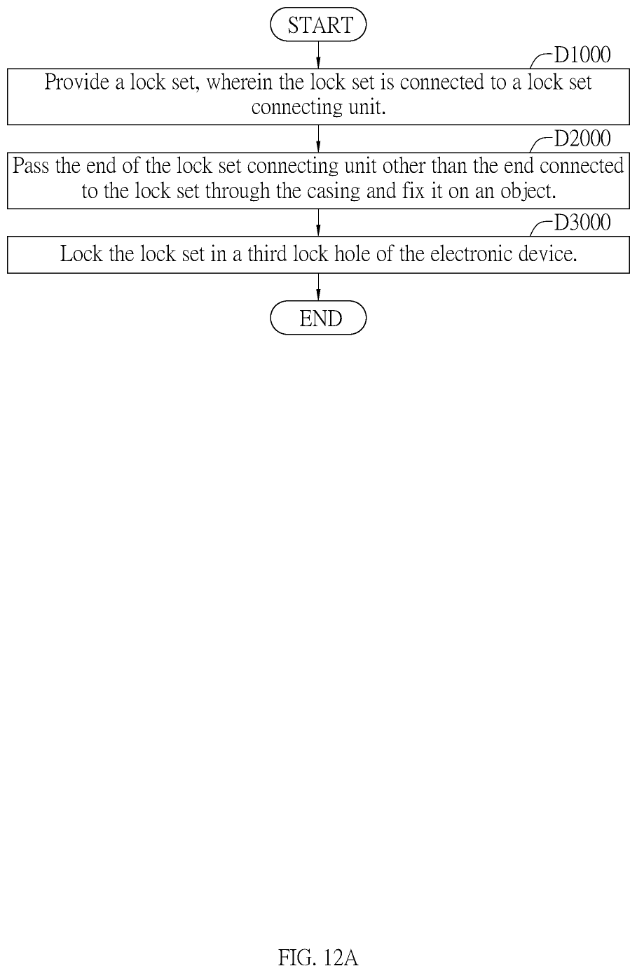

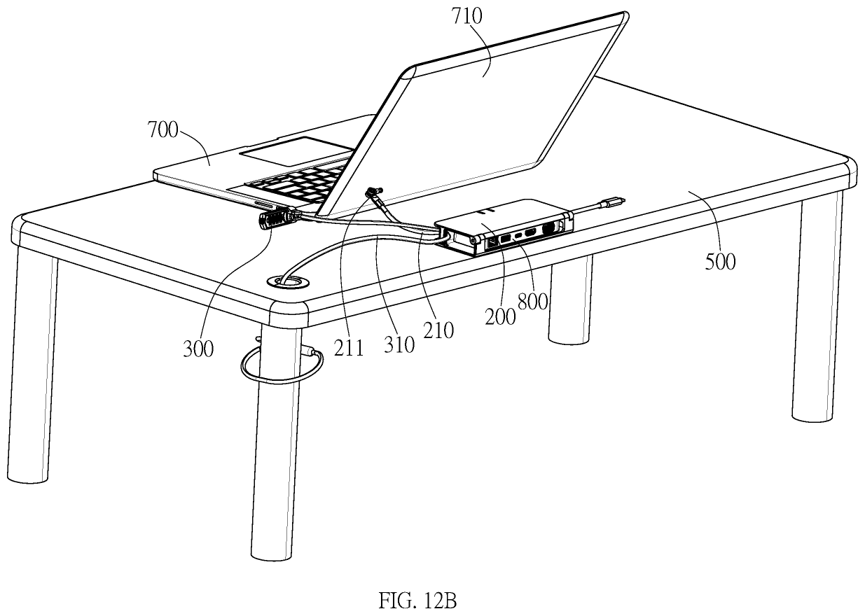

In different embodiments, the casing 200 can be used alone. As shown in the flowchart of a different embodiment shown in FIG. 12A, the method for using the stand lock kit of the present invention includes, for example, the following steps. Step (D1000): Provide a lock set, wherein the lock set is connected to a lock set connecting unit. Step (D2000): Pass the end of the lock set connecting unit other than the end connected to the lock set through the casing and fix it on an object. Step (D3000): Lock the lock set in a third lock hole of the electronic device. More particularly, as shown in the embodiment in FIG. 12B, the user can pass the end of the lock set connecting unit 310 other than the end connected to the lock set 300 through the casing 200, wind and fix it on a large object 500 such as a desk or a cabinet, and then lock the lock set 300 in the third lock hole 107 (see FIG. 1A). Thus, the electronic device 700 and the expansion electronic device 800 can further be locked on the object 500.

Accordingly, the stand lock and the casing of the stand lock kit of the present invention can be used independently in accordance with user requirement, which makes them more convenient to use. For example, as shown in the embodiments in FIGS. 10B and 11B, since the stand lock 100 is fixed on an object 500 such as a desk, the user merely needs to lock the electronic device 700 on the stand lock 100 and carry the casing, if any, with him when he leaves. As shown in the embodiments in FIG. 12B, since the casing 200 is fixed on an object 500 such as a desk, the user merely needs to lock the electronic device 700 using the lock set 300 when he leaves, and the electronic device 700 and the expansion electronic device 800 can be kept safe from theft simultaneously.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A stand lock kit for use with an expansion electronic device and an electronic device having a display, comprising:
a stand lock, including:
a body including at least a first lock hole, at least a stand lock core, and a first end portion and a second end portion disposed in the opposite ends of the body;
a first support arm disposed in the body; and
a second support arm disposed in the body, wherein at least one of the first support arm and the second support arm is capable of moving with respect to the body to secure the display of the electronic device between the first support arm and the second support arm and to make the relative position of the body with respect to the electronic device fixed; and
a casing having a casing connecting unit, wherein one end of the casing connecting unit connects to the casing and a free end of the casing connecting unit is capable of inserting into the first lock hole and being restricted from leaving the first lock hole by the stand lock core, wherein the expansion electronic device is accommodated in the casing.

2. The docking station according to claim 1, wherein the stand lock core is capable of restricting the movement of at least one of the first support arm and the second support arm to make the relative position of the body with respect to the electronic device fixed.

3. The stand lock kit according to claim 1, wherein the expansion electronic device is a docking station.

4. The stand lock kit according to claim 1, wherein the body further includes a second lock hole.

5. The stand lock kit according to claim 4, wherein a lock set can be locked in the second lock hole.

6. A method for using the stand lock kit according to claim 1, comprising:
(A1000) securing the display of the electronic device between the first support arm and the second support arm;
(A2000) inserting the free end into the first lock hole; and
(A3000) locking the stand lock core to restrict the free end from leaving the first lock hole and to restrict the movement of at least one of the first support arm and the second support arm to make the relative position of the body with respect to the electronic device fixed.

7. The method according to claim 6, further comprising:
(A4100) using a first cable to connect the casing connecting unit to an object.

8. The method according to claim 6, further comprising:
(A4200) locking a lock set in the second lock hole, wherein the lock set is connected to a lock set connecting unit.

9. The method according to claim 6, further comprising:
(A4300) fixing the body on an object.

10. A method for using the stand lock kit according to claim 1, comprising:
(B1000) securing the display of the electronic device between the first support arm and the second support arm;
(B2000) connecting one end of the first cable to an object and inserting the other end into the first lock hole; and
(B3000) locking the stand lock core to restrict the end of the first cable from leaving the first lock hole and to restrict the movement of at least one of the first support arm and the second support arm to make the relative position of the body with respect to the electronic device fixed.

11. A method for using the stand lock kit according to claim 1, comprising:
(C1000) securing the display of the electronic device between the first support arm and the second support arm;
(C2000) locking a lock set in the second lock hole, wherein the lock set is connected to a lock set connecting unit; and
(C3000) locking the stand lock core to restrict the end of the first cable from leaving the first lock hole and to restrict the movement of at least one of the first support arm and the second support arm to make the relative position of the body with respect to the electronic device fixed.

12. A method for using the stand lock kit according to claim 1, comprising:
(D1000) providing a lock set, wherein the lock set is connected to a lock set connecting unit;
(D2000) passing the end of the lock set connecting unit other than the end connected to the lock set through the casing and fixing it on an object; and
(D3000) locking the lock set in a third lock hole of the electronic device.
